(19) United States
(12) Patent Application Publication
(10) Pub. No.: US 2007/0277744 A1
(43) Pub. Date: Dec. 6, 2007

(54) Microcosm terrestrial and aquatic landscape habitat: a free standing "miniature mountain chain" topiary, upper pool, waterfall and pond-aquarium hybrid habitat with natural curves

(76) Inventor: Nicholas Joseph Gramza, Hamburg, NY (US)

Correspondence Address: Nicholas Joseph Gramza, 325 Brookwood Drive, Hamburg, NY, 14075, US

(21) Appl. No.: 11/445,984

(22) Filed: Jun. 2, 2006

(51) Int. Cl. A01K 63/00

(52) U.S. Cl. 119/253

(57) ABSTRACT

“The Microcosm Terrestrial and Aquatic Landscape Habitat” is a free-standing, fired-clay Topiary structure with Upper Pool, Waterfall and Pond-Aquarium Hybrid. It is built of fired stoneware clay shaped into naturalistic, “para-geological” forms of “miniature mountains” by my art craft. There is an Upper Pool for water on the rear “miniature mountain.” From the Upper Pool, a Water Course leads to a Waterfall constructed of clay, simulated “rocks.” The Waterfall splashes into a Main Catch Basin, a Pond. The Pond is framed by three “miniature mountain” structures, connected together into a loosely horse shoe shape. It is important to note that the gradiently sloping, support structure provided by the “miniature mountains” is a plausible emulation of naturally occurring geologies. In place of a fourth “miniature mountain” to enclose the Pond, the Pond is enclosed in front by a pane of glass ⅛ inch to ¼ inch thick. The pane of glass is adhered to the clay using silicon sealant. The Pond holds water. Thus, the “Microcosm Terrestrial and Aquatic Landscape Habitat” is a Topiary with an Upper Pool, Waterfall and Pond and Fish Tank Aquarium Hybrid. Nothing else like it exists. You can look at the device as a pond, or horizontally to see the underwater habitats as with a fish tank aquarium. As previously stated, the unit is free standing and can be easily moved around. Ceramics glazes, water, submersible electric fountain pump, tube, terrestrial plants, aquatic life like fish, amphibians, mollusks and crustaceans complete the device. The support slopes (mini-mountains) which structure the “Microcosm Terrestrial and Aquatic Landscape Habitat” are para-geological, sloping and naturalistically pleasing. These structural support slopes are embellished with nooks,

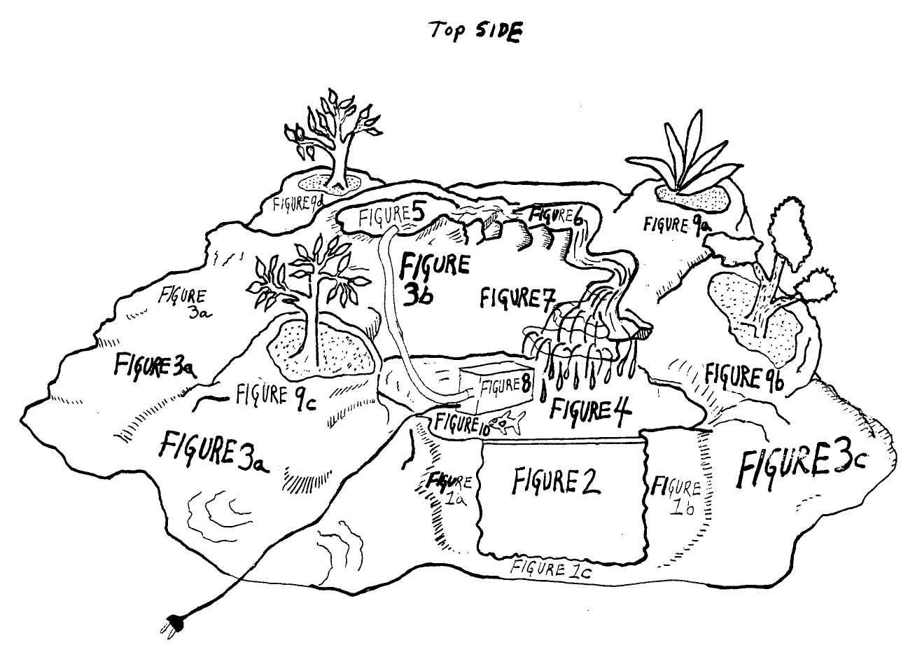

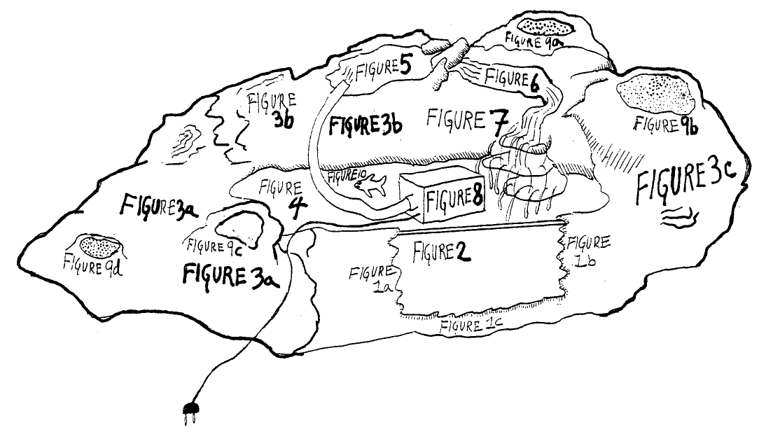

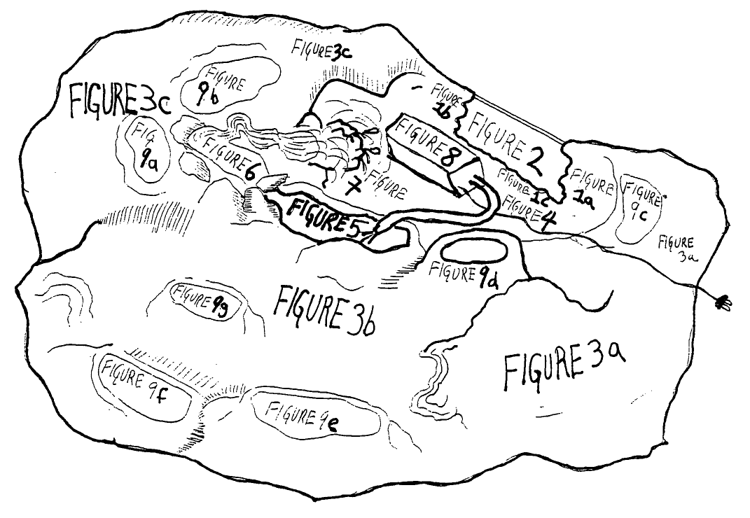

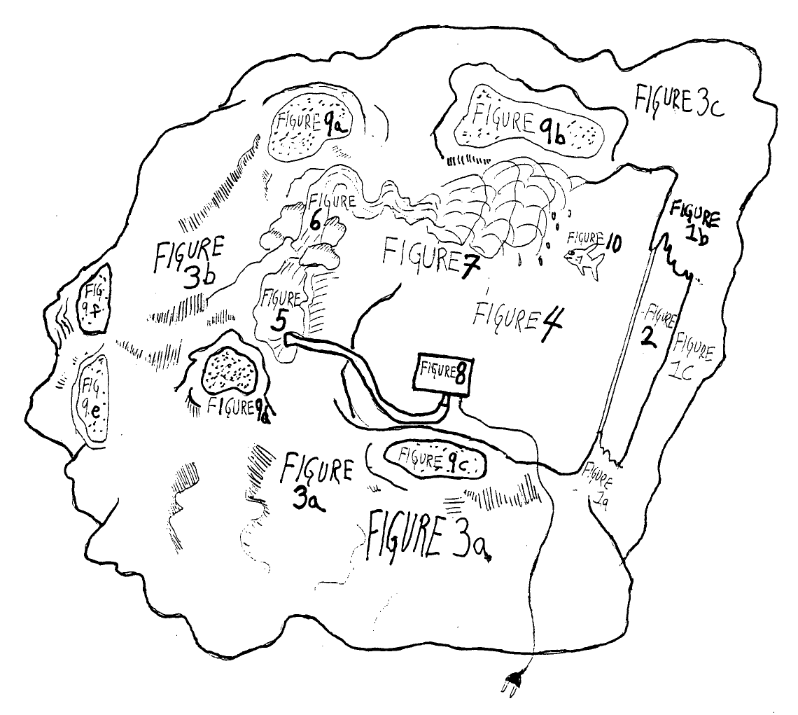

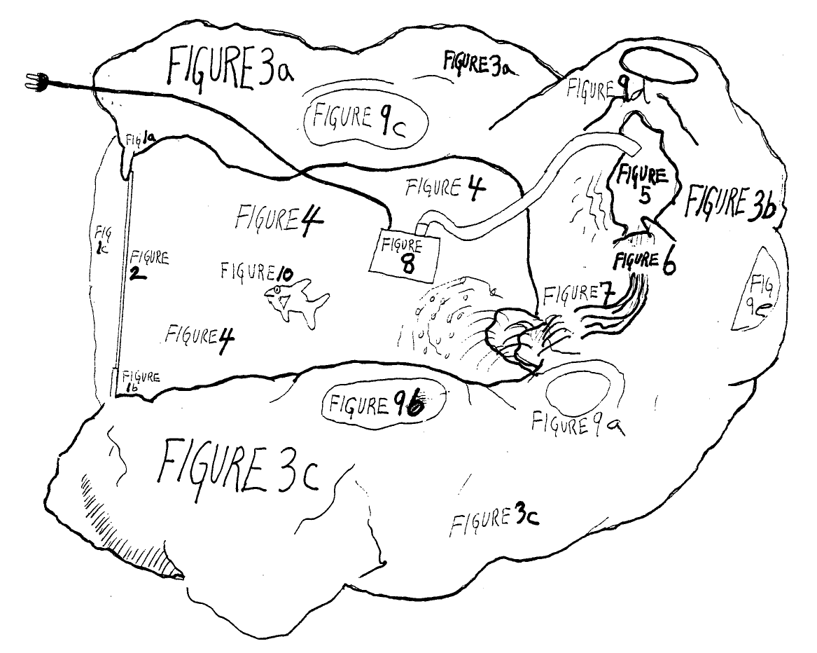

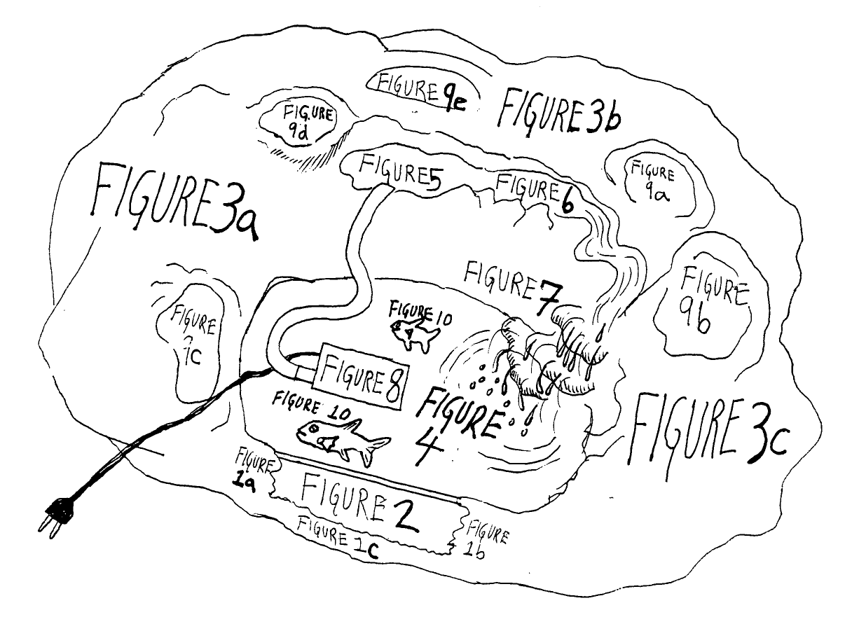

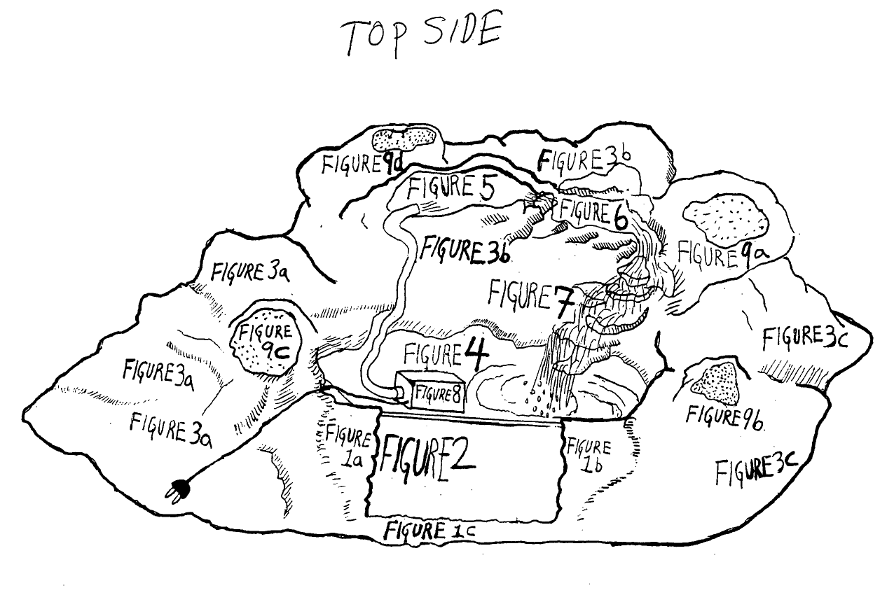

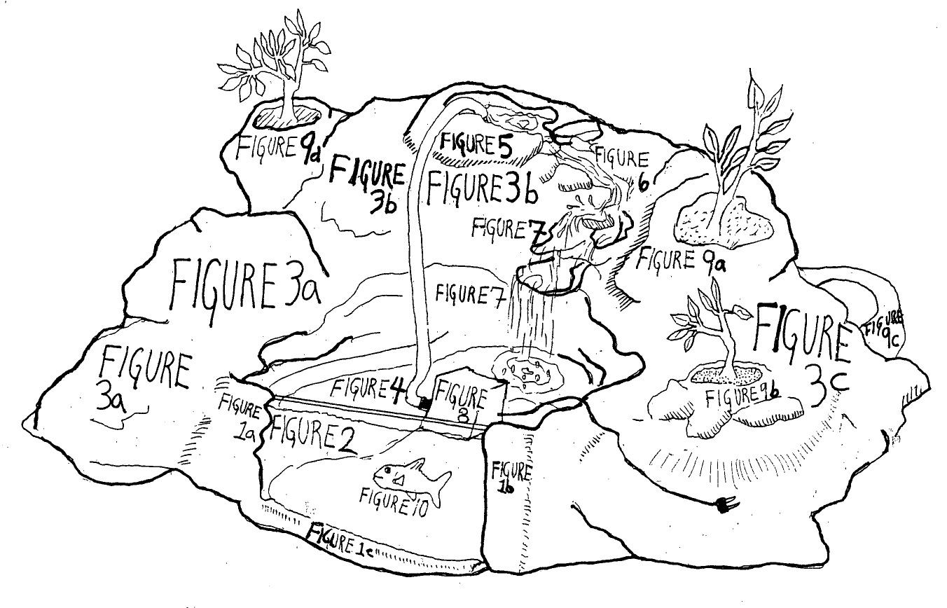

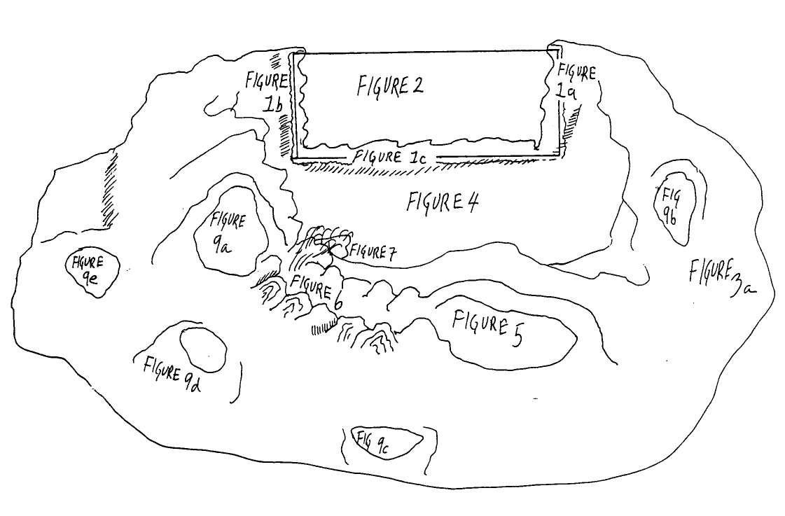

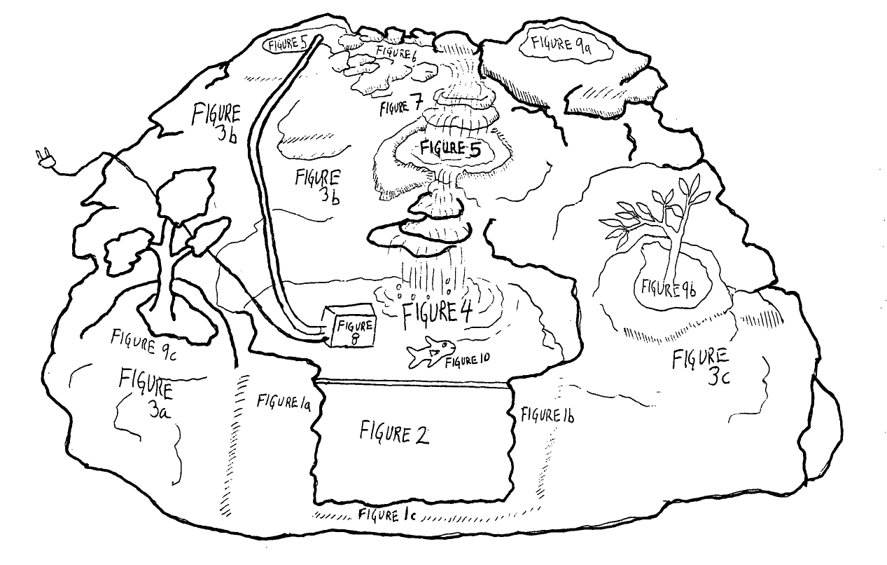

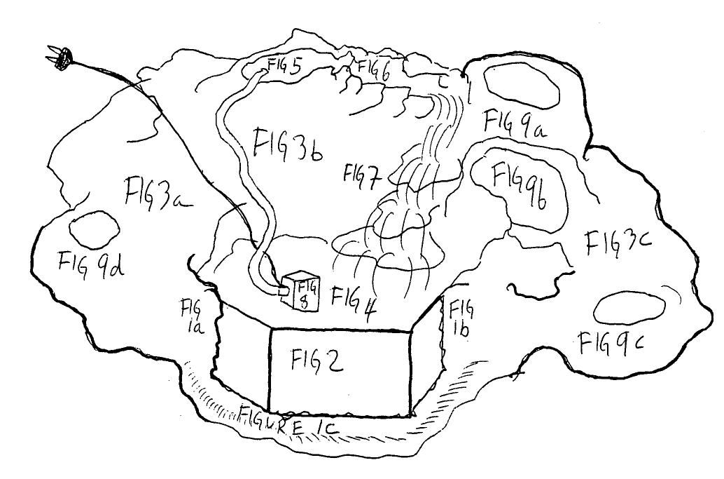

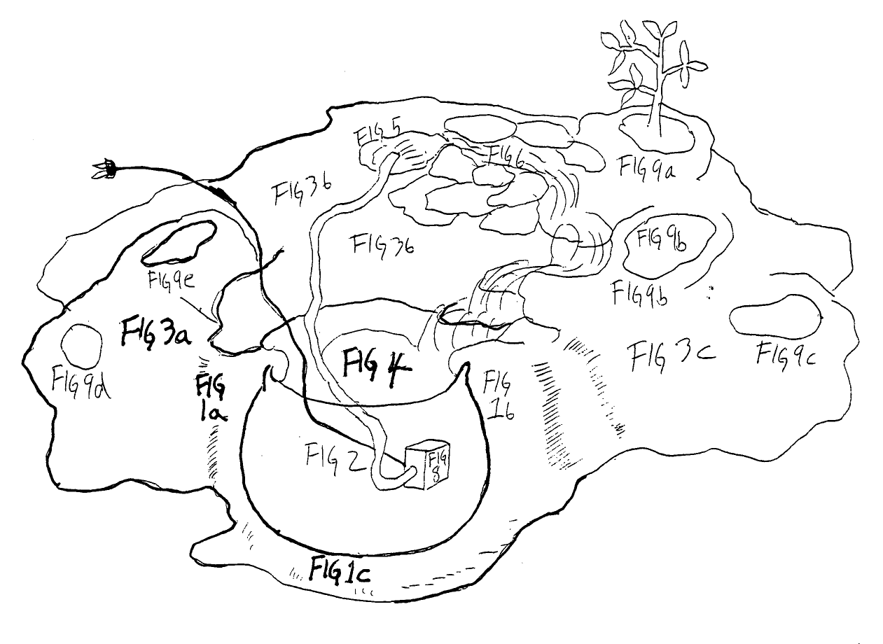

### BACKGROUND OF THE INVENTION

I invented this device in 1998 while a student in the Clifford Furnace Ceramics School at the University at Buffalo (Witnesses can vouch for this—including teachers, friends, relatives, a retired New York State Police Officer with twenty years distinguished service. I also have United States Post Office Certified letters mailed to myself and sealed with USPO date stamps containing drawings and specifications of the invention). Dissatisfied with traditional arrangements for keeping captive toads, in class I started making a basin, a clay pond to more naturalistically house my pets. Since the sculpture was to be kept indoors on a table and not buried in the ground, I decided to make the outer walls of the pond sloping to make the piece look like something natural. I had the idea to make the walls look like miniature or bonsai mountains around the Pond. I laid soft, wet clay over cardboard boxes which would then get burned in bisque firing; I made the under frame of cardboard boxes so that I could slab onto it ¾ inch to 1.5 inch thick slabs of wet clay. I made the under frame of cardboard boxes horse shoe shaped. The clay which I slabbed over the boxes made three connected “miniature mountains.” I made the contours of these outer support slopes, the “miniature mountains,” para-geological and naturalistically pleasing by adding nooks, buttes, cliffs, miniature knolls and by impressing field stones on the clay while it was still wet to give the surface natural contours. I made pots built into the structure which later house bonsai trees and other terrestrial plants. (The clay of the pots melds and bonds to the uni-body of the entire piece.) I made crevices, nooks, buttes, cliffs and slopes which mimicked nature on the surface of the pond's exterior. I built the pots for terrestrial plants around these para-geological formations. On top of the rear “miniature mountain” which frames the Pond, I hand built an Upper Pool. (This structural feature, too, is made of clay which melds and bonds into the uni-body of the entire piece.) From this top pool leads a short, depressed Water Course (embellished with simulated clay “rocks”) and then comes a Waterfall made of pieces of clay designed to look like rocks, which are staggered to give the Waterfall a splashing effect. The Waterfall drains into the Main Basin of the Pond itself, aerating the water. Then eureka struck. I realized that I would only be able to look at my toads from above if I enclosed all sides of the basin with slope walls. Why not leave the front “wall” of the pond open—no fourth, front exterior slope. I could then hybridize pond AND aquarium!!! I attached ½ inch wide clay strips to the vertical interior sides, right and left, of the “mountains” where they came together where the front slope would connect if I had not left that portion open. I beveled a clay strip the same size, ¼ inch to ½ inch, along the bottom of the front, level with the Pond Basin's floor, left to right; latitudenally. After I bisque fired and glaze fired the unit, I grafted a ⅛ inch thick pane of glass to the front of the Pond, to these clay strip frames, using silicon sealant. Eureka!! A Pond which has a window into the underwater world for level, horizontal viewing of specimens, but which is naturalistically a pond to be viewed from above also. A pond and fish tank-aquaria hybrid! I decided this device would be perfect not only for toads, but especially for tropical fish.

“The Microcosm Terrestrial and Aquatic Landscape Habitat” is a unique, functional habitat for keeping and breeding tropical fish, other aquatic life and terrestrial plants. It combines novel elements of Topiary, para-geological structure-frame, garden pond with underwater viewing option of fish tank aquarium as provided for by the piece of glass grafted onto the front portion of the clay structure. “The Microcosm Terrestrial and Aquatic Landscape Habitat” is a topiary habitat for multiple terrestrial plants. It also provides for the maintenance of aquatic creatures. It is unique also because of its small scale. The Waterfall powered by mechanical electric pump aerates the water in the Main Catch Basin Pond which sustains life of aquatic creatures.

### SUMMARY OF THE INVENTION

“The Microcosm Terrestrial and Aquatic Landscape Habitat” is a unique and useful invention for the cultivation and propagation of terrestrial and aquatic plants, the rearing and breeding of tropical fish, crustaceans, amphibians and mollusks. It is a naturalistic looking habitat. It is a unique hybrid of free standing miniature mountain chain (three mountains) Topiary, Upper Pool, Waterfall, and Catch Basin Pond and glass AQUARIUM front. The inner basin—Main Pond Basin—is formed by the three “miniature mountain structures,” loosely horse shoe shaped, chained together to define and shape the Pond, with organically formed topiary features. There is a Waterfall proceeding from a pool which is located on top of, and as part of, the rear mountain. After the water from the Upper Pool flows down the Waterfall, it splashes into the Main Pond Basin. In the Main Pond Basin there is a window of glass grafted onto the clay-strip frames of the front of the Main Pond Basin—glass is grafted to clay with silicon sealant—at the front of the Main Pond Basin; this thus allows for horizontal viewing of the underwater habitats in the Main Pond Basin, like a fish tank aquaria in this one respect. I generally make my units out of clay, but I seek patent in all media—cast resins, fiberglass, ceramics, all clays, plastics, polymers, etc. Although I usually make my units 20″ L×20″ W×22″ Diameter and 13″ Height, they can be made in nearly any size.

“The Microcosm Terrestrial and Aquatic Landscape Habitat” is truly a thing of beauty, emulating pleasing geological strata on a small scale. What better way to bring natural life into your space? It is the perfect contemplation piece to ponder indoors in the home or office. It appeals to all the senses . . . visual, artistic, aquatic and floral, too! As a consumer, I would select the “Microcosm Terrestrial and Aquatic Landscape Habitat” over the traditional glass shoebox aquarium any day.

“The Microcosm Terrestrial and Aquatic Landscape Habitat” is a useful device beyond being a novel container for plants and animals. It is furthermore useful because inside the Main Pond Basin I submerge an electrical fountain pump which circulates the water through a tube back up to the Upper Pool which is situated attached on the rear “mountain”. This water then goes out of the Upper Pool, down the Watercourse I have constructed and over the Waterfalls I have constructed. When this water falls back into the Pond (Main Pond Basin), it is aerated to bring oxygen to the tropical fish and other organisms living in the Main Basin Pond. To raise tropical fish and other aquatic life as well as terrestrial plants in this mechanical device is the purpose of this invention. It is a Microcosm Habitat for terrestrial AND aquatic life, a sort of open air biodome or bio-mound for the creation and maintenance of a small ecosystem. So, you have mini-mountain chain surrounding a Pond, with Waterfall coming from a pool on the top of the rear mountain piece. The Waterfall splashes into the Main Catch Basin Pond-Aquarium hybrid. The front of the pond is formed by a pane of glass grafted with silicon sealant onto the clay of the side mountains. This enables you to look at your fish from above, as with a traditional pond, or to look in at your fish through a single pane of glass as with an aquarium. Refer to pictures and drawings enclosed.

If one of the pots that are formed alongside the pond's edge is deep enough, a mechanical box filter may be fitted inconspicuously inside this and thus further water filtration provided for the fish and other specimens.

“The Microcosm Terrestrial and Aquatic Landscape Habitat” is an unique topiary pond which also serves, via its single pane of glass, as an aquarium for level, horizontal viewing of specimens; thus the unit is naturalistically a pond with rounded, curving sides and edges and natural, sloping contours to be viewed with interest from any angle. The quintessential idea with the “miniature mountain” support structure is to make it resemble naturally occurring geology as much as possible. Built into this uni-body structure of clay are three to ten or more pots emulating natural “gorge” formations (and other para-geologies) which are intended to contain terrestrial plants, especially bonsai trees. The topiary function is very important to the functional aesthetic of this piece. This unit is unique to fish ponds in that is exceptionally easy to maintain.

### DETAILED DESCRIPTION OF THE INVENTION

Manner and Process of Making “The Microcosm Terrestrial and Aquatic Landscape Habitat”.

I start with a suitably sized square of plywood, 23″×23″. I lay down a piece of cardboard 23″×23″. I arrange milk cartons, juice boxes and other various cardboard boxes into an approximately horse shoe shape. I tape these boxes together and to the cardboard on which they rest. I add crumpled newspaper with tape to the exteriors of the boxes to create slopes and gradients. Then I ball up stoneware clay (Cone 6 to Cone 10) and flatten the balls of clay into clay pancakes. I assemble these together over the cardboard understructure, adhering each clay pancake to another. When completed I hand build pots onto the outer surface. (clay bonds with clay to form uni-body) These will hold terrestrial plants. There may be three to ten or more pots. I impress field stones onto the clay while it is still wet to leave the imprint of natural rock lines, contours of natural rocks.

When viewed level, the Front of the unit is open, lacking a front side, fourth sloping wall. That is to say, the three “miniature mountains” which chain together to frame the Pond do not meet a fourth, enclosing “miniature mountain.” In place of the fourth “miniature mountain” I graft a ⅛ inch to ¼ inch thick piece of glass cut to fit the dimensions of the front opening; to graft the glass to the clay I use silicon sealant. Along the inner sides of the right and left “miniature mountains”—where they form the very front sides of the Main Pond Basin—along these vertical sides of the right and left horse shoe “miniature mountains,” I press rolled strips of clay. I also press a rolled strip of clay along the front bottom where the front is open (latitude of front bottom), level with the floor of the Main Pond Basin. These rolled strips of clay I adhere while moist to the clay of the Pond's floor and, respectively, to the side “miniature mountains.” I then flatten these rolled strips of clay to ¼ inch to ½ inch thickness. These will be the clay frames onto which a single pane of glass (⅛ inch to ¼ inch thick) is adhered with silicon sealant after glaze firing. (I adhere the glass while the clay is still wet to make the inner surfaces of the frames flat and a tight seal with the glass; then I remove the glass for later.) To belabor the obvious, the height and width of this piece of glass is cut, by me, to fit the dimensions of the front Pond opening.

I make the Upper Pool on top of the rear “miniature mountain.” I place this Upper Pool a few inches away from the down slopes of the “miniature mountains” so that, in its scale, the Upper Pool looks like a feasible piece of geology. To further this naturalizing effect, I place two or more naturalistically edged pots for bonsai trees next to or adjoining the Upper Pool. The clay used for the Upper Pool melds and bonds into the uni-body clay of the entire piece. From the Upper Pool's open, raised mouth runs a short Water Course embellished with simulated clay rocks. Then comes the precipitous drop of the Waterfall. I make the rock arrangement of the Waterfall as intricate as possible so that when the piece is finished and water is added, the Waterfall will create a nice gurgling, splashing effect, acoustically pleasing and doing the job of aerating the Main Pond Basin water. On the sides of the Watercourse and Water fall (incorporating rear and side mountains) I construct hand built pots to form an edge inches higher than the Watercourse and Waterfall themselves so that when water flows through the Watercourse and Waterfall, the water will not splash out of the unit.

I impress “field stone” patterns into the soft clay to give the impression of geological strata. I make cliffs, nooks, rocks, buttes, emulations of natural erosion, etc. on the surface of the wet clay to complete the naturalistic design.

Drying of the clay takes two to four weeks. Then it is Bisque fired at a Cone temperature appropriate to the clay being used. I use Cone 6 to Cone 10 clay. Then I glaze fire “The Microcosm Terrestrial and Aquatic Landscape Habitats” using standard ceramics glazes of various colors. When cooled, I take a suitably sized ⅛ inch to ¼ inch thick piece of glass cut to fit the frame and adhere this to the inner surfaces of the clay frames using silicon sealant. Refer to drawings and photographs. Drying of silicon sealant takes 48 hours. Then I place an aquatic fountain pump (electric) in the Main Pond Basin of the unit. A tube runs from pump in Main Pond Basin to Upper Pool located on rear side “mountain.” Put water into “The Microcosm Terrestrial and Aquatic Landscape Habitat” up to a suitable level, plug in the pump and watch the wonder of a naturalistic waterfall into your own topiary, pond-AQUARIUM hybrid. Add tropical fish. View form from above as a pond-topiary or horizontally as with a fish tank aquarium. Add bonsai and other plants to the three to ten or more pots I have built into the uni-body structure of the piece. buttes, cliffs, miniature knolls and by impressing field stones on the clay while it was still wet to give the surface natural contours.

I generally make my units out of clay, but I seek patent in all media—cast resins, fiberglass, ceramics, all clays, plastics, polymers, etc. Although I usually make my units 20″ L×20″ W×22″ Diameter and 13″ Height, they can be made in nearly any size.

“The Microcosm Terrestrial and Aquatic Landscape Habitat” is a useful device beyond being a novel container for plants and animals. It is furthermore useful because inside the Main Pond Basin I submerge an electrical fountain pump which circulates the water through a tube back up to the Upper Pool which is situated attached on the rear “mountain”. This water then goes out of the Upper Pool, down the Watercourse and over the Waterfalls I have constructed. When this water falls back into the Pond, it is aerated to bring oxygen to the tropical fish and other organisms living in the Main Basin Pond.

The topiary function for terrestrial plants is very important to the functional aesthetic of this piece. Pots for plants are built into the clay structure—especially to house bonsai trees and other terrestrial plants. (The clay of the pots melds and bonds to the uni-body of the entire piece.) I make crevices, nooks, buttes, cliffs and slopes which mimic nature on the surface of the pond's exterior. I build the pots, for terrestrial plants, around these para-geological formations.

To raise tropical fish and other aquatic life as well as terrestrial plants in this novel mechanical device is the purpose of this invention. It is a Microcosm Habitat for terrestrial and aquatic life, a sort of open air bio-dome or bio-mound for the creation and maintenance of a small ecosystem.

“The Microcosm Terrestrial and Aquatic Landscape Habitat” is very different from any fountains on the market. None of these combine the elements of: topiary for terrestrial plants; rounded naturalistic edges surrounding the pond; naturalistically sloping exterior equipped for terrestrial plants; Upper Pool which is part of the rear mountain's geology, subsequent Waterfall and then Main Pond Basin shaped by natural curves resembling a natural mountain pond with a front pane of glass grafted with silicon sealant onto the clay frames where the side mountains meet the “front” for horizontal, underwater viewing of specimens (fish, mollusks, amphibians) contained there-in. Fountains available look man made, artificial and have flat backs and sides OR are built so large as that they need to be anchored to walls. “The Microcosm Terrestrial and Aquatic Landscape Habitat” may be easily lifted up and moved around. “The Microcosm Terrestrial and Aquatic Landscape Habitat” is an artificial topiary landscape designed to emulate natural forms. It is most unique in that it is a garden or desk top pond and aquaria hybrid. The pond is formed by simulated “miniature mountains” of clay with organically formed surrounding topiary structure. The Upper Pool and Waterfall circulate water. In the front this device contains a window of glass for horizontal viewing of the underwater habitats in the Main Pond Basin, like a fish tank aquaria in this one respect. But, Aquaria have square sides all around and so do not truly mimic a natural environment as the “Microcosm Terrestrial and Aquatic Landscape Habitat” does.

The aquarium trade offers waterfalls and pools made of fiberglass or plastics which may be placed INSIDE your square or rectangular fish tank. None of these are free standing. None of them compare with the overall effect of “The Microcosm Terrestrial and Aquatic Landscape Habitat.”

1. I claim to have invented a novel ecological device suitable to be kept indoors in the home or office. I call my device the “Microcosm Terrestrial and Aquatic Landscape Habitat.” It is a free-standing Topiary structure with Upper Pool, Waterfall and Pond-Aquarium Hybrid. It is built of fired stoneware ceramic clay shaped into naturalistic, “para-geological” forms of “Miniature Mountains” by my art craft. These “Miniature Mountains” made of fired clay are the structural support of the device. There is an Upper Pool for water on the rear “Miniature Mountain.” From the Upper Pool, a Water Course leads to a Waterfall constructed of simulated “rocks” made of clay. The Waterfall splashes into a Main Catch Basin, a Pond. The Pond is formed and framed by three “Miniature Mountain” structures, connected together into a loosely horse shoe shape. These three “Miniature Mountains” (“Bonsai Mountains”, if you like) are chained together to define and shape the Pond, with organically formed topiary features. My quintessential idea in creating these “Miniature Mountains” is to make them emulate natural geologies as much as possible. In place of a fourth “Miniature Mountain” to enclose the Pond, the Pond is enclosed in front by a pane of glass which is ⅛ inch to ¼ inch thick. The pane of glass is adhered to the clay using silicon sealant. The Pond holds water. Thus, the “Microcosm Terrestrial and Aquatic Landscape Habitat” is a Topiary with an Upper Pool, Waterfall and Pond and Fish Tank Aquarium Hybrid. Nothing else like it exists. You can look at the device as a pond, or horizontally to see the underwater habitats as with a fish tank aquarium. As previously stated, the unit is free standing and can be easily moved around. Refer to drawings and photographs which I have provided.

1. Ceramics glazes, water, submersible electric fountain pump, tube, terrestrial plants, aquatic life like fish, amphibians, mollusks and crustaceans complete the device.

2. The support slopes (“miniature mountains”) which structure the “Microcosm Terrestrial and Aquatic Landscape Habitat” are para-geological, sloping and naturalistically shaped. These structural support slopes are embellished with nooks, buttes, cliffs, miniature knolls and by impressing field stones on the clay while it was still wet to give the surface natural contours. The idea with these “Miniature Mountain” support structures is to make them resemble naturally occurring geology as much as possible. They must be strong enough to support the device and hold water.

3. I generally make my units out of clay, but I seek patent in all media—cast resins, fiberglass, ceramics, all clays, plastics, polymers, etc.

4. Although I usually make my units 20″ L×20″ W×22″ Diameter and 13″ Height, they can be made in nearly any size.

5. On top of the rear “miniature mountain” which frames the pond, I hand built a top, Upper Pool. (This structural feature, too, is made of clay which melds and bonds into the uni-body of the entire piece.) I place this Upper Pool a few inches away from the down slopes of the “miniature mountains” so that, in its scale, the Upper Pool looks like a feasible piece of geology. To further this naturalizing effect, I place two or more naturalistically edged pots for bonsai trees next to or adjoining the Upper Pool. From this top, Upper Pool leads a connected, short, Water Course (depressed into the clay frame of the rear “miniature mountain” and embellished with simulated clay “rocks” to contain the water and for splash effects, acoustic value and aesthetics) and leads into a Waterfall made of pieces of clay designed to look like rocks, which are staggered to give the Waterfall a splashing effect.

6. The Waterfall pours into the Main Catch Basin of the Pond itself, aerating the water. The Waterfall is powered by an electrical submersible fountain pump located in the Main Catch Basin Pond. Attached to this pump is a tube which leads up to the Upper Pool.

7. “The Microcosm Terrestrial and Aquatic Landscape Habitat” is a useful device beyond being a novel container for plants and animals. It is furthermore useful because inside the Main Pond Basin I submerge an electrical fountain pump which circulates the water through a tube back up to the Upper Pool which is situated attached on the rear “mountain”. This water then goes out of the Upper Pool, down the Watercourse and over the Waterfalls I have constructed. When this water falls back into the Pond, it is aerated by the Waterfall action to bring oxygen to the tropical fish and other organisms living in the Main Basin Pond.

2. To raise tropical fish and other aquatic life as well as terrestrial plants in this mechanical device is the purpose of this invention. It is a Microcosm Habitat for terrestrial and aquatic life, a sort of open air bio-dome or bio-mound for the creation and maintenance of a small ecosystem.

8. The topiary function for terrestrial plants is very important to the functional aesthetic of this piece.

9. If one of the pots that are formed alongside the Main Pond's edge is deep enough, a mechanical box filter may be fitted inconspicuously inside this and thus further water filtration provided for the fish and other specimens.

10. On the sides of the Watercourse and Water fall (incorporating rear and side mountains) I construct hand built pots to form an edge inches higher than the Watercourse and Waterfall themselves so that when water flows through the Watercourse and Waterfall, the water will not splash out of the unit.

11. Pots for plants are built into the clay structure—especially to house bonsai trees and other terrestrial plants. (The clay of the pots melds and bonds to the uni-body of the entire piece.) I make crevices, nooks, buttes, cliffs and slopes which mimic nature on the surface of the Pond's exterior. I build the pots, for terrestrial plants, around these para-geological formations.
